(19) United States
(12) Patent Application Publication
(10) Pub. No.: US 2008/0068151 A1
(43) Pub. Date: Mar. 20, 2008

(54) SURVEILLANCE SYSTEM AND METHOD FOR OPTIMIZING COVERAGE OF A REGION OF INTEREST BY A SENSOR

(76) Inventors: Dror Ouzana, Haifa (IL); Iovav Cohen, Tel Aviv (IL); Shay Peretz, Shimshit (IL); Ittai Bar-Joseph, Shimshit (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/531,330

(22) Filed: Sep. 13, 2006

(51) Int. Cl. G08B 19/00; H04N 7/18

(52) U.S. Cl. 340/521; 348/143

(57) ABSTRACT

A method for programming scanning parameters of a programmable sensor comprising a sensing element, the sensor positioned in a precinct to scan a region of interest of the precinct, the method comprising simulating scanning at least some of the region of interest according to a plurality of strips; and optimizing the scanning parameters by comparing between the areas covered by each strip according to at least one property of the area.

### FIELD OF THE INVENTION

The present invention relates generally to the field of planning the scanning parameters of a sensor in a precinct using computer-aided design. More specifically, the present invention provides a system and method that plans the scanning parameters, such as sensor pitch, roll and yaw, of a sensor.

### BACKGROUND OF THE INVENTION

Sensors that enable scanning a region of interest and that provide an observer with information regarding the presence, the movement or both of, for example, vehicles, persons and the like, are well-known in the art. Such sensors may be, for example, security cameras, radars and the like. Sensor scanning parameters such as, e.g., pitch, roll and yaw, may be programmable.

Such a sensor may be implemented as presented by Choi, “Movable security camera apparatus”, U.S. Pat. No. 5,327,233; or as presented by Taillade, “Video surveillance system with mobile camera”, patent number EP1494480, which are both incorporated by reference for all purposes as if fully set forth herein. Furthermore, such a programmable sensor may be implemented as presented by Koshiio, “System and device for security mobile monitoring”, patent number JP2000268285; or as presented by Hsieh, “Programmable high-speed tracing and locating camera apparatus”, US patent application No. US200500466, which are both incorporated by reference for all purposes as if fully set forth herein. In order to optimize the operation of such a sensor (i.e. minimizing scanning time and/or maximizing coverage of the region of interest), a user has to program the sensor's scanning parameters accordingly. However, implementations of the above-referenced publications lack a system, an apparatus, a method or a combination thereof, that enables the user to program the scanning parameters ill a manner that optimizes the operation of the sensor.

### SUMMARY OF SOME EMBODIMENTS OF THE INVENTION

In embodiments of the invention, a method for programming scanning parameters of a programmable sensor comprising a sensing element is presented. The sensor is positioned in a precinct to scan a region of interest of the precinct. The method comprises, inter alia, simulating scanning at least some of the region of interest according to a plurality of strips; and optimizing the scanning parameters by comparing between the areas covered by each strip according to at least one property of the area.

In embodiments of the invention, properties of the area refer to one of the following: distance covered by each strip, size of the area covered by each strip, weight of a section covered by at least one of the strips. The weights indicate importance of the section.

In embodiments of the invention, the method further comprises sorting the strips according to at least one of the properties of the area.

In embodiments of the invention, the method further comprises selecting a group of strips. The group comprises a predetermined number of strips that cover the largest area within the region of interest.

In embodiments of the invention, the method further comprises determining the area covered by the strips by counting the number of pixels covered by each respective strip.

In embodiments of the invention, the strip comprises a substantially single pitch angle and of a plurality of azimuth angles.

In embodiments of the invention, the strip comprises a substantially single azimuth angle and a plurality of pitch angles.

In embodiments of the invention, the strip comprises a plurality of pitch angles and azimuth angles.

In embodiments of the invention, the method further comprises determining a maximal scanning range of the sensor.

In embodiments of the invention, the method further comprises simulating positioning the sensor within the precinct to generate a visibility map that enables maximizing, within the region of interest, a zone being in direct line-of-sight with the sensing element.

In embodiments of the invention, the method further comprises determining a sequence of traversing the group of strips. The sequence is determined in a manner such that the scanning time of at least some of the region of interest is minimized.

In embodiments of the invention, the method further comprises minimizing the scanning time by determining the sequence such that the angular difference between two strips is minimal compared to the angular difference between other strips.

In embodiments of the invention, a system for programming scanning parameters of a programmable sensor is presented. The system comprises a graphic processing module enabling simulation of scanning at least some of the region of interest according to a plurality of strips and analyzing The module optimizes the scanning parameters by comparing between the areas covered by each strip according to at least one property of the area.

In embodiments of the invention, the analyzing module sorts the strips according to at least one property of the area.

In embodiments of the invention, the analyzing module selects a group of strips, which comprises a predetermined number of strips that covers the largest area of the region of interest.

In embodiments of the invention, the analyzing module determines the area covered by each strip by counting the number of pixels covered by each respective strip.

In embodiments of the invention, the analyzing module determines a maximal scanning range of the sensor.

In embodiments of the invention, the graphic processing module enables simulating the position of the sensor within the precinct to generate a visibility map. The visibility map enables maximizing of a zone being in direct line-of-sight with the sensing element, within the region of interest.

In embodiments of the invention, the graphic processing module indicates in the visibility map the zoom ranges of the sensor.

In embodiments of the invention, the analyzing module determines a sequence of the strips of the group such that a scanning time of at least some of the region of interest is minimized.

In embodiments of the invention, the analyzing module determines a sequence of traversing the group of strips, i.e., the scanning sequence, such that the angular difference between two strips is minimal compared to the angular difference between other strips.

In embodiments of the invention, the system further comprises a workstation and a sensor wherein the scanning parameters are transmitted from the workstation to the sensor.

In embodiments of the invention, the scanning parameters are updated substantially in real-time during the operation of the sensor.

In embodiments of the invention, the region of interest is altered during the operation of the sensor.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a surveillance system, according to an embodiment of the invention;

FIG. 2 is a schematic illustration of a map of a precinct wherein a position and a maximal scanning range of a sensor are indicated; and wherein a zone in direct line-of-sight is indicated, according to an embodiment of the invention;

FIG. 3 is a schematic illustration of a map of the precinct wherein an additional position of the sensor and a region of interest are indicated, according to an embodiment of the invention;

FIG. 4 is a schematic illustration of a map of the precinct, wherein the section outside of the region of interest is cropped, according to an embodiment of the invention;

FIG. 5 is a schematic illustration of the region of interest wherein the zoom ranges of the sensor are indicated;

FIG. 6 is a schematic illustration of the region of interest wherein the zoom ranges and their corresponding magnification factors are indicated, according to an embodiment of the invention;

FIG. 7 is a schematic illustration of the region of interest, virtually segmented with a grid;

FIG. 8a is a schematic, isometric illustration of the topography, depicted by a grid, of the region of interest, according to an embodiment of the invention;

FIG. 8b is another schematic, isometric illustration of the topography, depicted by the grid, of the region of interest, according to an embodiment of the invention;

FIG. 9 is a schematic illustration of a method for graphically depicting zoom ranges within a region of interest, according to an embodiment of the invention; and

FIG. 10 is a schematic illustration of a method for optimizing the scanning parameters of the sensor.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention relates to a novel system and method that optimizes positioning and controlling of a sensor to detect, track, monitor, warn or any combination of the above, a user of the system about a movement or presence or both of persons, vehicles and the like within a precinct. Such a precinct may be, for example, a landscape region, a building, a hall, a prison, a section of a street, an airport, a train station, an underground train station, a border crossing, a military base, a shopping mall, an airport and the like. The sensor may be, for example, a security camera, a radar and the like.

Scanning parameters of the sensor, such as pitch, roll and yaw, are optionally programmable as known in the art. The sensor is operatively associated with adjustable gears, which are operatively associated with a drive. The drive enables adjustment of the gears, and therefore adjustment of the sensor, according to the programmed scanning parameters. For example, the user may program the sensor to traverse and thereby scanning a region of interest within the precinct according to the following scanning parameters: pitch: 0.125*π radians, start azimuth angle: 0 radians, end azimuth angle: π radians. By starting the operation of the sensor, the sensor starts a scanning process in which at least some part of the region of interest is scanned according to the programmed scanning parameters.

It is the purpose of the present invention to provide a system and/or method that enable programming the sensor in a manner such that the scanning time of the region of interest is minimized and/or the coverage of the region of interest is maximized.

It is to be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one off the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” refers to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

For exemplary purposes only, a scanning process in which the pitch remains substantially constant while the azimuth is changed, is hereinafter referred to as a strip, though it is to be understood that the invention is not to be viewed as limiting in this regard. For example, in some embodiments of the invention, a strip may be defined as a scanning process in which the pitch or the azimuth or both may have constant or varying angles.

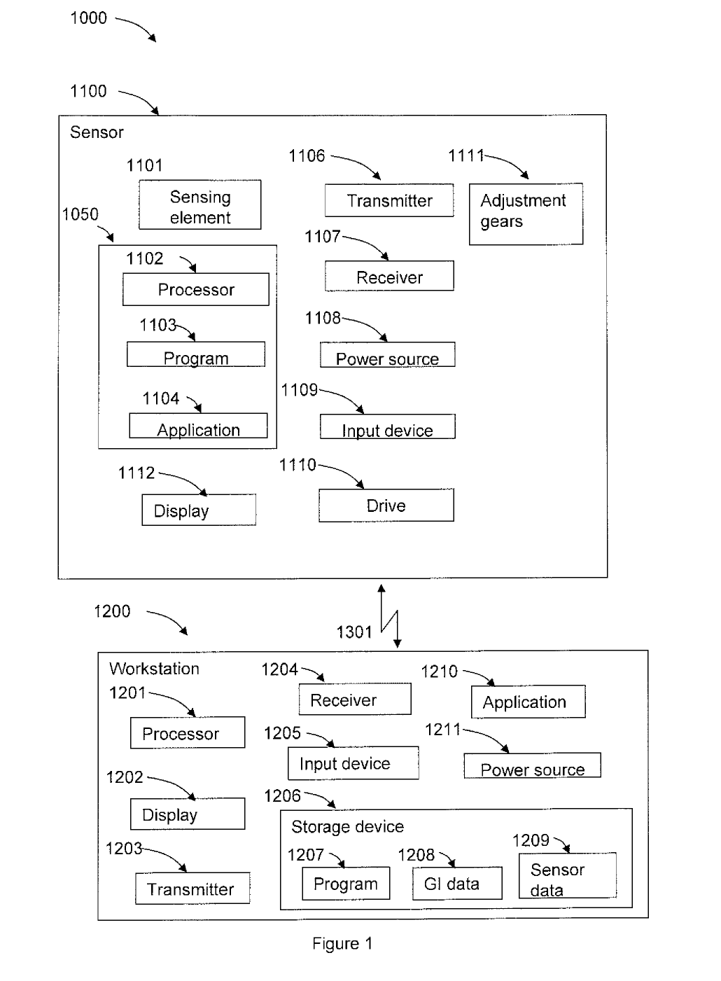

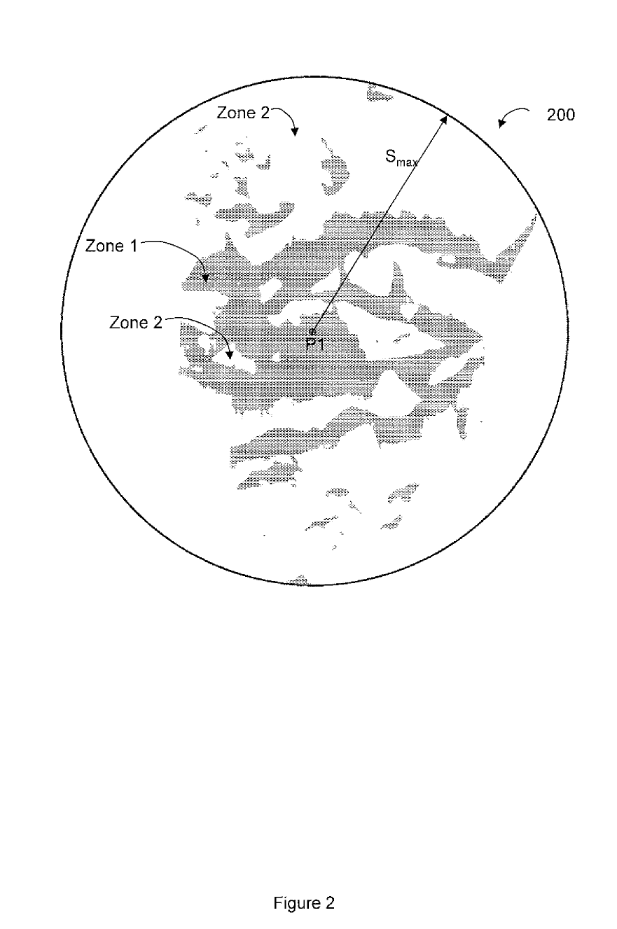

Reference is now made to FIG. 1, which schematically illustrates a surveillance system 1000, according to an embodiment of the invention, and to FIG. 2, which schematically illustrates a top view of a map of a precinct 200 (hereinafter referred to as “precinct map 200”) indicating therein the position and the maximal scanning range of a sensor 1100. In addition, the zone that is in direct line-of-sight with a sensing element 1101 is indicated in precinct map 200.

According to some embodiments of the invention, sensing element 1101 is included in sensor 1100, which is part of a surveillance system 1000. Sensing clement 1101 may be, for example, an imager or any other suitable sensing element. The sensing element 1101 is operatively associated with a processor 1102. Sensor 1100 further includes a transmitter 1106, a receiver 1107, an interface device 1109, adjustment gears 1111 and a display 1112, all of which are operatively associated with processor 1102 and/or with storage device 1113. Adjustment gears 1111 enable adjusting, for example, the pitch, roll, yaw, height and the like, of sensor 1100 and/or sensing element 1101.

Sensing element 1101, processor 1102, transmitter 1106, receiver 1107, interface device 1109 and drive 1110 are operatively associated with power source 1108 and adapted to receive electrical power. Furthermore, processor 1102 is adapted to read and execute a program 1103.

Non-limiting examples of sensor 1100 are a camera, a video camera, a stereo-camera, a laser detector, a thermal camera, a laser scanning device, a passive sensor, an active sensor or any combination thereof.

According to some embodiments of the invention, processor 1102 may execute program 1103 resulting in an application 1104 that, inter alia, controls movement of adjustment gears 1111 via drive 1110 according to the scanning parameter set by the user.

According to some embodiments of the invention, program 1103 is modifiable via interface device 1109, or remotely from a workstation 1200 via wire or wireless signals 131, which may be sent from transmitter 1203 to receiver 1107. Transmitter 1203 may be operatively associated with processor 1201 or storage device 1206, and receiver 1107 may be operatively associated with a module 1050. Module 1050, which may based on hardware and/or software, is adapted to determine scanning parameters (hereinafter referred to as “optimized scanning parameters”) that maximize the coverage of a region of interest 220 and/or minimize the time required to scan region of interest 220, as will be outlined below.

According to some embodiments of the invention, module 1050 may include a processor 1201 operatively associated with a power source 1211. Both processor 1201 and power source 1211 are operatively associated with a display 1202, a transmitter 1203, a receiver 1204, an interface device 1205 and a storage device 1206 that stores therein, inter alia, data representing a program 1207, which may also be included in module 1050. Storage device 1205 also stores data that represents geographical information (GI) data 1208 of a precinct. GI data 1208 represents, for example, information regarding landscape topography, latitude, meridians, streets, location of buildings, purpose of the buildings (e.g., hospital, police station, embassy, school, apartment building and the like), location of constructions sites, roadblocks, army posts, vegetation and the like. Processor 1201 may process GI data 1208 in a manner that results in a visualization of said GI data 1208 on, e.g., display 1202. Therefore, display 1202 may display maps of landscape regions, city maps, maps of building compounds and the like. Furthermore, storage device 1205 may store sensor data 1209 representing the parameters of sensor 1100, such as sensor type, model number, size, weight, zoom range, pitch range, roll range, yaw range, availability, cost and the like.

According to some embodiments of the invention, processor 1201 may execute program 1207 resulting in an application 1210 that uses GI data 1208, sensor data 1209 or both to determine optimized scanning parameters, as will be outlined below with reference to FIGS. 2-10.

According to some other embodiments of the invention, sensor 1100 may store therein GI data 1208, and processor 1102 may execute program 1103 resulting in an application 1104 that, inter alia, determines optimized scanning attributes based on GI data 1208. In some other embodiments of the invention, GI data 1208 may be generated, for example, substantially in real-time as sensor 1100 scans the precinct, i.e., the scanned information representing the precinct may be stored in storage device 1206 as GI data 1208.

According to some embodiments of the invention, the user may read the optimized scanning parameters from display 1202 and modify program 1103 accordingly.

According to some embodiments of the invention, sensor 1100 may be programmed with the optimized scanning parameters by transmitting data representing said optimized scanning parameters via signals 1301 from transmitter 1203 to receiver 1107. Other methods for updating program 1103 of sensor 1100 may also be possible.

According to some embodiments of the invention, the optimized scanning parameters may be updated during the operation of sensor 1100. For example, during the operation of sensor 1100, the user may redefine region of interest 220 (hereinafter referred to as “new region of interest 220”) via interface device 1205 or interface device 1109. As a result, the optimized scanning parameters may no longer be suitable for ensuring optimized operation of sensor 1100. Therefore, the optimized scanning parameters may be updated accordingly by, e.g., application 1210 and/or application 1104.

According to some embodiments of the invention, sensor 1100 may scan at least some area of the precinct and send data (hereinafter referred to as “scanning data”) representing the scanned area to workstation 1200. The scanning data may then be compared against GI data 1208 by, e.g., application 1210. If there is a mismatch between the scanning data and GI data 1208, a suitable warning message may be displayed on display 1112 and GI data 1208 may be updated accordingly, in order to ensure maximal coverage of region of interest 220 and/or minimal scanning time of region of interest 220.

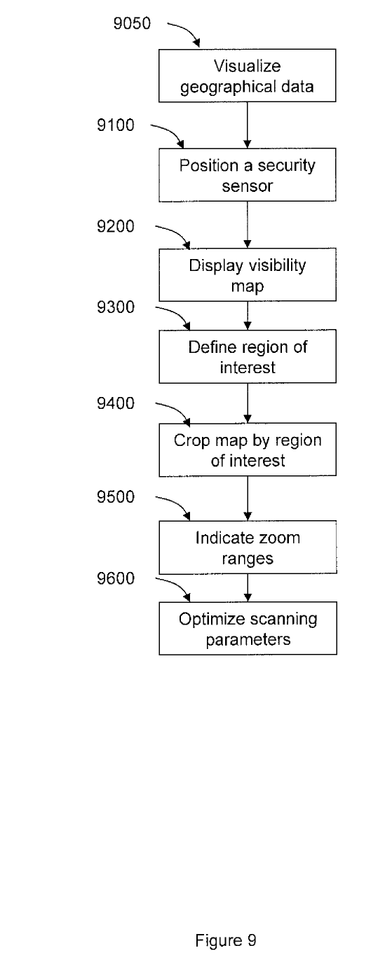

Further reference made to FIG. 9, which schematically illustrates a method for graphically depicting zoom ranges within region of interest 220, according to an embodiment of the invention. The various zoom ranges may be marked on display 1202, e.g., with different colors.

As indicated by box 9050, the method may include, for example, the step of schematically visualizing a precinct such as, e.g., precinct 200. This may be accomplished by retrieving the part of GI data 1208 that represents precinct 200 and depicting said data as precinct map 200 on display 1202.

As indicated by box 9100, the method may include, for example, simulating a position of a sensor, such as sensor 1100, within precinct map 200. This may be accomplished by the user selecting, via interface device 1205, sensor data 1209 that matches the operating parameters of sensor 1100 and providing processor 1201 with information regarding the position of sensor 1100 in precinct map 200. As a result, display 1202 displays the position and the maximal scanning range Sₘₐₓ of sensor 1100, as schematically depicted in FIG. 2.

As indicated by box 9200, the method may further include, for example, generating a visibility map 210 by, e.g., application 1210. Visibility map 210 depicts which zones of precinct 200 (within Sₘₐₓ) have a direct line-of-sight (LOS) with sensing element 1101 and which do not. For example, as schematically illustrated in FIG. 2, a Zone Z1 may indicate a region having a direct LOS with sensing element 1101 and a second Zone Z2 may indicate a region that has no direct LOS with sensing element 1101. The shape of each zone depends, inter alia, on the height of sensing element 1101 above the ground of precinct 200.

According to some embodiments of the invention, application 1210 and/or application 1107 determine the size of each zone. Additionally or alternatively, application 1210 and/or application 1107 determine the percentage of the region of interest 220 covered by Z1. Therefore, application 1210 and/or application 1107 determine the position for sensor 1100 that is providing the best coverage of region of interest 220.

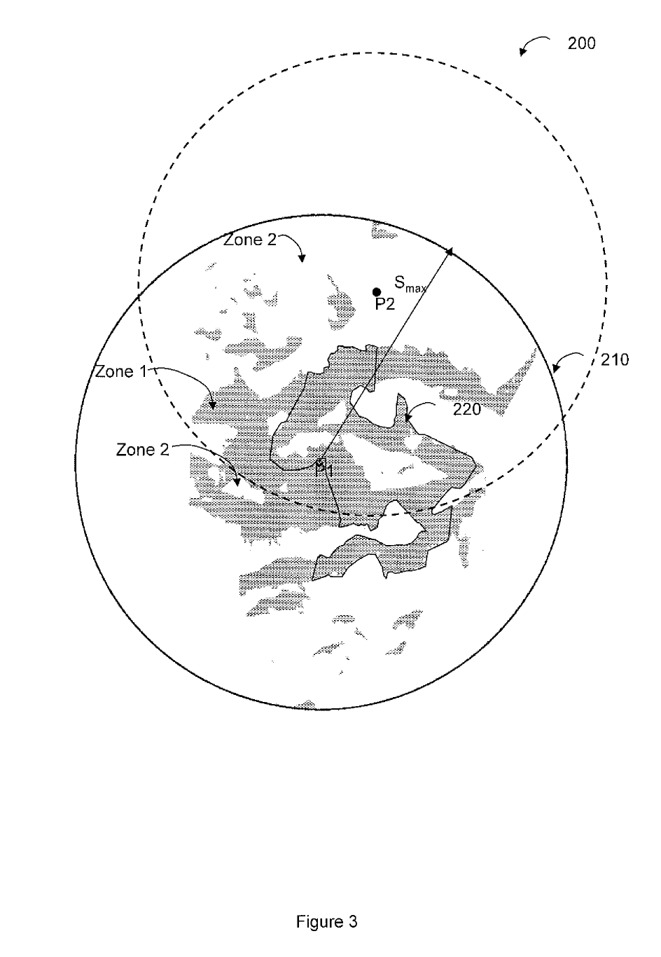

Additional reference is now made to FIG. 3, which schematically illustrates precinct map 200, wherein a region of interest 220 is delineated and an alternative position of sensor 1100 is indicated, according to an embodiment of the invention.

As indicated by box 9300, the method may include, for example, the step of defining the region of interest 220, which is defined as the region that the user wants to surveil. According to some embodiments of the invention, application 1210 may simulate different positions for virtual sensor 1100 and determine the position that provides the maximal coverage of region of interest 220 by zone Z1. For example, at position P1, application 1210 may determine that zone Z1 covers 85% of region of interest 220, whereby at position P2, application 1210 determines that zone Z1 covers only 70% of region of interest 220. Therefore, application 1210 may determine to place virtual sensor 1100 at position P1.

According to some embodiments of the invention, the positioning of a sensor, such as sensor 1100, may be performed as described in “A method for Planning a Security Array of Sensor Units”, U.S. utility patent application Ser. No. 11/278,860, which is incorporated by reference for all purposes as if fully set forth herein and which claims priority from provisional patent application 60/772,557. U.S. provisional patent application 60/772,557 is also incorporated by reference for all purposes as if fully set forth herein.

It is to be understood that in some embodiments of the invention, sensor 1100 may be one sensor in an array of sensors. Therefore, the sensor parameters of one or more additional sensors may have to be taken into account in order to position sensor 1100 optimally in precinct 200.

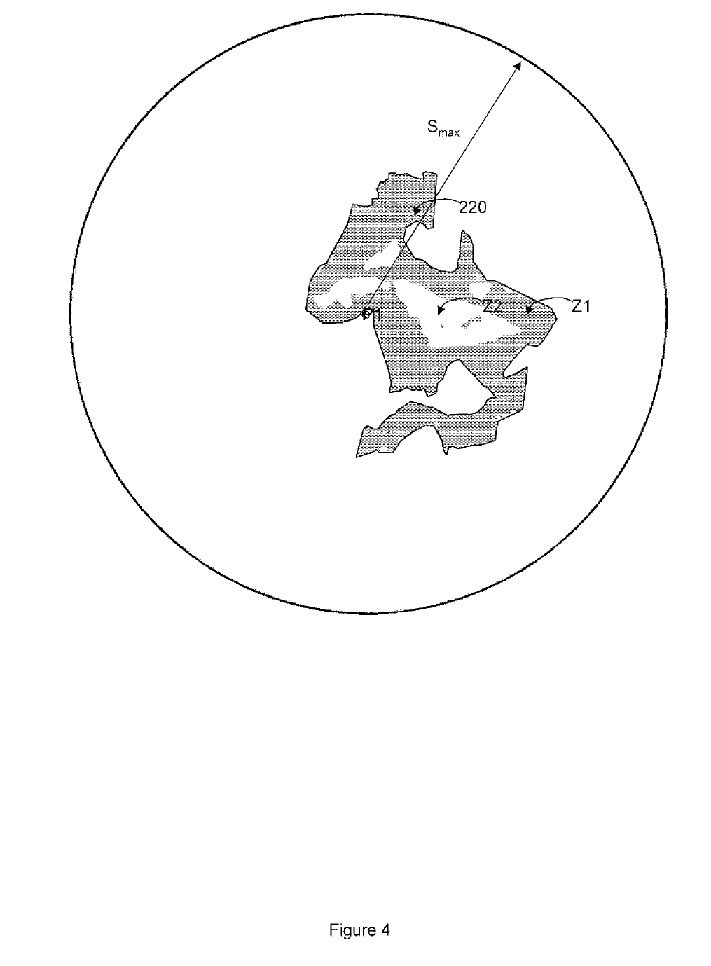

Reference is now also made to FIG. 4, which schematically illustrates visibility map 210, wherein the section outside of said region of interest 220 is cropped, according to an embodiment of the invention.

As indicated by box 9400, the method may include, for example, the step of cropping the visibility map 210 in a manner such that only region of interest 220 is displayed on display 1202.

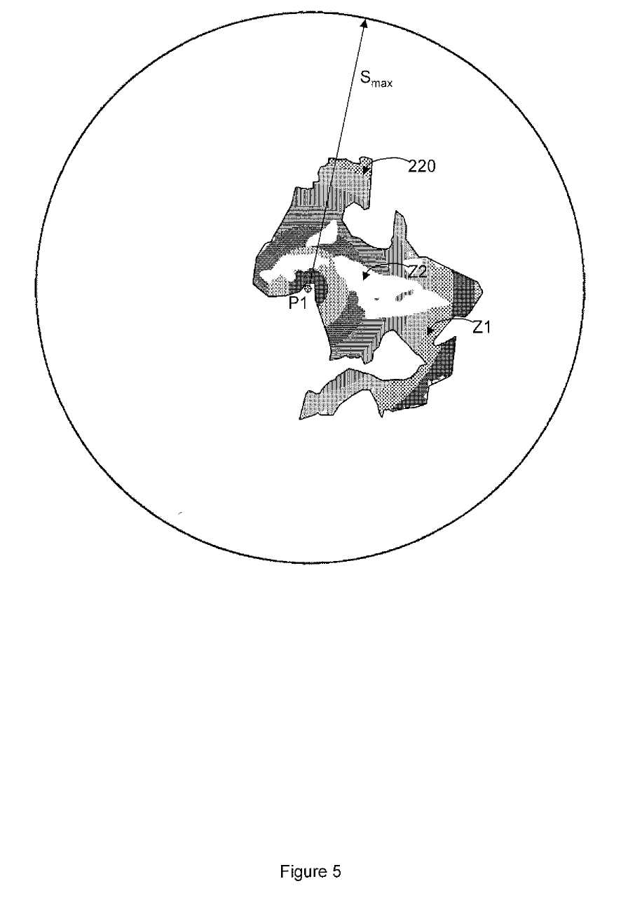

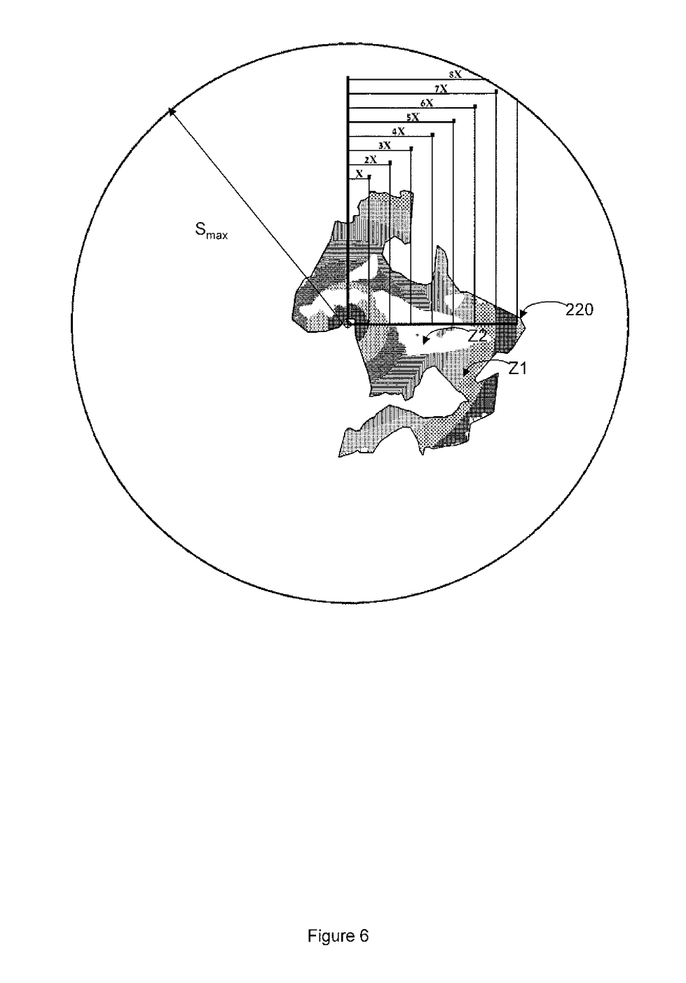

Further reference is now made to FIG. 5, which schematically illustrates region of interest 220, wherein the zoom ranges of sensor 110 are indicated; and to FIG. 6, which schematically illustrates the zoom ranges and their corresponding magnification factors, according to an embodiment of the invention.

As indicated by box 9500, the method may include, for example, the step of indicating the zoom ranges of, e.g., sensing element 1101, on display 1202. In some embodiments of the invention, sensor 1100 may be constrained to traverse a strip, i.e., scan an area according to a strip, within a certain zoom range. A relationship may exist between the zoom ranges and the vertical fields of view (VFOV) of sensing element 1101, i.e., the VFOV may depend on, inter alia, the zoom range of sensing element 1101. For example, at a VFOV of 11.74 rad, the zoom range may be 0-500 m; at a VFOV of 5.87 rad, the zoom range may be 500 m-100 m; and at a VFOV of 3.91 rad, the zoom range may be 1000-1500 m.

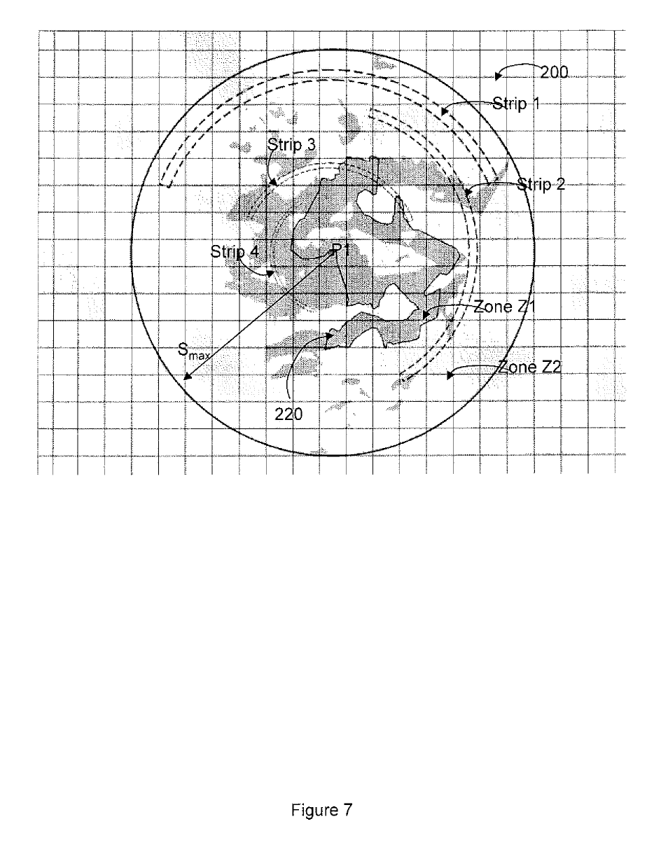

As indicated by box 9600, the method may include, for example, the step of optimizing the scanning parameters of sensor 1100, as will be outlined hereinafter with reference to FIG. 7, 8a, 8b and 10.

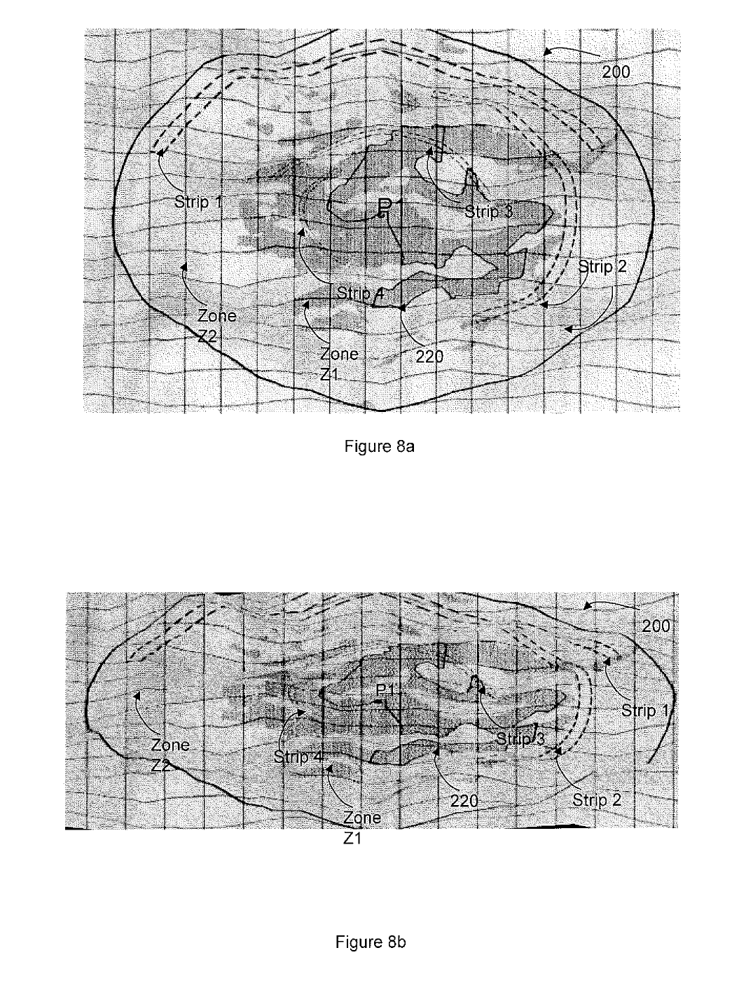

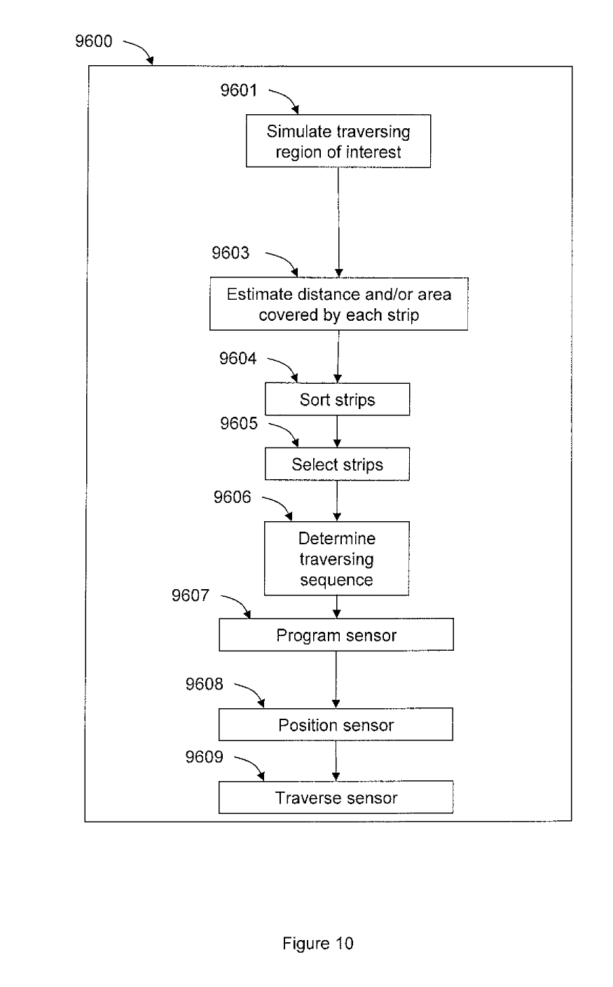

Reference is now made to FIG. 7, which schematically illustrates a map of a section of region of interest 220 whose topography is schematically depicted by a grid, according to an embodiment of the invention. Furthermore, reference is made to FIGS. 8a and 8b, each schematically illustrating an isometric view of a section of region of interest 220, virtually segmented by the grid. Additional reference is made to FIG. 10, which schematically illustrates a method for optimizing the scanning parameters of sensor 1100, according to an embodiment of the invention

As indicated by box 9601, in order to optimize the scanning parameters, the method may include, for example, the step of simulating scanning at least some portion of region of interest 220 according to a plurality of strips (hereinafter referred to as “strip array”) in order to determine how many strips are needed to cover substantially all of region of interest 220. For example, as depicted in FIG. 7, application 1210 may determine that four strips are sufficient to cover substantially all of region of interest 220.

According to some embodiments of the invention, the range of the azimuth angles, i.e., the length of each strip, may be determined by first simulating scanning region of interest 220 with strips each having substantially equal lengths when projected on a substantially flat surface. In order to obtain strips each having substantially equal lengths, a decrease in the pitch angle may require increasing the azimuth angle accordingly.

According to some embodiments of the invention, the range of the azimuth angles may be determined by, e.g., application 1210, in a manner such that each strip is scanned by sensor 1100 in substantially the same amount of time.

According to some embodiments of the invention, additional properties such as the length of a strip and/or the time required to traverse a strip, i.e., the time required to scan the area covered by said strip, may be taken into account when determining optimized scanning parameters.

As indicated by box 9602, the method may include, for example, the step of redefining region of interest 220. The user may redefine region of interest 220 in order to reduce the number strips and therefore the time required to cover substantially the entire redefined region of interest 220.

As indicated by box 9603, the method may include, for example, the step of investigating the properties of the area covered by each strip within region of interest 220 such as, for example, the distance and/or the size of at least some of said area. This may be accomplished, for example, by determining the number of pixels that are covered by each strip within region of interest 220 using GI data 1208. For example, within region of interest 220, strip 1 may cover 850 pixels, strip 2 may cover 9240 pixels, Strip 3 may cover 2810 pixels and Strip 4 may cover 10510 pixels. In some embodiments of the invention, a pixel may correspond to one square meter. In consequence, application 1210 may determine therefrom that strip 1, strip 2, strip 3 and strip 4 cover an area of 850 m², 9240 m², 2810 m² and 10510 m², respectively.

As indicated by box 9604, the method may include, for example, the step of sorting the strips according to the distance and/or area covered by the strips within region of interest 220. The strips may be sorted, e.g., in a descending order, as follows: strip 4 (10510 m²), strip 2 (9240 m²), strip 3 (2810 m²) and strip 1 (850 m²).

According to some embodiments of the invention, region of interest 220 may be sectioned according to weights, whereby each weight indicates a measure of importance regarding imperativeness to be scanned. For example, the weights may be, for example, 1, 2 and 3, representing ‘not important’ section, ‘important’ section and ‘very important’ section, respectively. The weights of each section may be taken into account when determining the optimized scanning parameters. For example, the weights may be prioritized by, e.g., the user, over the area covered by each strip. Therefore, the strips may first be sorted according to their weights and only then according to, e.g., the area covered by each strip. For example, if the weight of aforementioned strips are as follows: strip 1 (weight 2), strip 2 (3), strip 3 (1) and strip 4 (3), then the strips will be sorted as follows: strip 4 (weight: 3, area: 10510), strip 2 (weight: 3, area: 9240), strip 1 (weight 2, area: 850) and strip 3 (weight: 1, area: 2810).

According to some embodiments of the invention, two strips may partially overlap, for for example, in order to scan more frequently a particular section that has a weight that is higher than the weights of any other section, i.e., said particular section is more important than other sections of region of interest 220.

If a plurality of strips cover substantially the same number of pixels, then the strip to be included in the strip array may be determined by, e.g., the user or according to the weights of the section.

As indicated by box 9605, the method may include, for example, the step of selecting a number of strips (hereinafter referred to as “strip selection”) from the strip array, according to which sensor 1100 traverses to scan at least some of region of interest 220. The strip selection refers to the group of strips that cover the largest area of region of interest 220. The number of strips in the strip selection may depend on, for example, the number of zoom ranges according to which sensing element 1101 is operable. For example, application 1210 or the user may determine that region of interest 220 is sufficiently covered by four strips. Each strip may be in a different zoom range. However, sensing element 1101 may be operable only at, e.g., three zoom ranges. Therefore, application 1210 may determine that the strip selection comprises three strips. In consequence, region of interest 220 is scanned according to strip 4, strip 2 and strip 1.

As indicated by box 9606, the method may include, for example, determining the sequence between the strips of the strip selection. The sequence may be determined by, e.g., application 1210.

The scanning sequence determines the time (hereinafter referred to as “scanning time”) it takes sensor 1100 to complete traversing all strips of the strip selection. Consequently, the scanning time of at least some of region of interest 220 is, inter alia, a function of the scanning sequence.

According to some embodiments of the invention, the scanning sequence may be determined in a manner such that the scanning time is substantially minimized. This is accomplished, inter alia, by determining the scanning sequence in a manner such that the time it takes sensor 1100 and/or sensing element 1101 to adjust between two strips is minimized,

The larger the distance between a first and a second strip, the larger the difference between the first and second pitch angle of sensor 1100, respectively and the more time it takes for sensor 1100 to adjust from the first pitch to the second pitch. Consequently, application 1210 may determine a scanning sequence in a manner that minimizes the difference of: a current pitch angle and a subsequent pitch angle.

Similarly, the larger the distance between a first and a second azimuth angle, the more time it takes for sensor 1100 to adjust from the first to the second azimuth angle. Consequently, application 1210 may determine a scanning sequence in a manner that also minimizes the difference between a first azimuth angle and a second azimuth angle.

It is to be understood that a scanning sequence may comprise, in some embodiments of the invention, strips that have various azimuth, pitch angles or both.

As indicated by box 9607, the method may include, for example, the step of programming sensor 1100, i.e., updating program 1103, according to the optimized scanning sequence.

As indicated by box 9608, the method may include, for example, the step of positioning sensor 1100 in precinct 200 as determined by, e.g., application 1210.

As indicated by box 9609, the method may include, for example, the step of traversing sensor 1100 and/or sensing element 1101 as determined by, e.g., application 1210. Accordingly, at least some portion of region of interest 220 is scanned optimally by sensor 1100 and/or sensing element 1101.

Additionally or alternatively, parameters such as the composition of the ground and the number and/or type of buildings may be taken into account when determining the optimized scanning parameters.

According to some embodiments of the invention, sensor 1100 scans region of interest 220 according to the optimized scanning parameters, until sensor 1100 homes in on a target such as a vehicle (e.g., a tank), a person (e.g., a soldier) or the like.

It is to be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, Java, Pascal, MATLAB, BASIC, Cobol, Fortran, assembly language, machine code and the like.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for programming scanning parameters of a programmable sensor comprising a sensing element, said sensor positioned in a precinct to scan a region of interest of said precinct, said method comprising:
a) simulating scanning at least some of said region of interest according to a plurality of strips; and
b) optimizing said scanning parameters by comparing between the areas covered by each strip according to at least one property of said area.

2. The method of claim 1, wherein said property of the area refers to at least of the following: distance covered by each strip, size of the area covered by each strip, weight of a section covered by a strip, said weight indicating importance of the section.

3. The method of claim 1, further comprising sorting the strips according to at least one of said properties.

4. The method of claim 1, further comprising selecting a group of strips, said group comprising a predetermined number of strips that cover the largest area within said region of interest.

5. The method of claim 1, further comprising determining said property by counting the number of pixels covered by each strip.

6. The method of claim 1, wherein said strip comprises a substantially single pitch angle and of a plurality of azimuth angles.

7. The method of claim 1, wherein said strip comprises a substantially single azimuth angle and a plurality of pitch angles.

8. The method of claim 1, wherein said strip comprises a plurality of pitch angles and azimuth angles.

9. The method of claim 1 further comprising determining a maximal scanning range of said sensor.

10. The method of claim 1 further comprising simulating positioning said sensor within said precinct to generate a visibility map that enables maximizing, within said region of interest, a zone being in direct line-of-sight with said sensing element.

11. The method of claim 4, further comprising determining a sequence of traversing said group of strips, said sequence determined in a manner such that the scanning time of at least some of said region of interest is minimized.

12. The method of claim 4, further comprising minimizing the scanning time by determining said sequence such that the angular difference between two strips is minimal compared to the angular difference between other strips.

13. A system for programming scanning parameters of a programmable sensor, said system comprising:
a) a graphic processing module enabling simulation of scanning at least some of a region of interest according to a plurality of strips; and
b) an analyzing module for optimizing said scanning parameters by comparing between the areas covered by each strip according to at least one property of the area.

14. The system of claim 13, wherein said property of the area refers to at least one of the following: distance covered by each strip, size of the area covered by each strip, weight of a section covered by a strip, said weight indicating importance of the section.

15. The system of claim 13, wherein said analyzing module sorts the strips according to at least one of said property.

16. The system of claim 13, wherein said analyzing module selects a group of strips, said group comprising a predetermined number of strips that covers the largest area of said region of interest.

17. The system of claim 13 wherein said analyzing module determines said property by counting the number of pixels covered by each strip.

18. The system of claim 13, wherein said strip comprises a substantially single pitch and of a plurality of azimuth angles.

19. The system of claim 13, wherein said strip comprises a substantially single azimuth angle and a plurality of pitch angles.

20. The system of claim 13, wherein said strip comprises of a plurality of pitch angles and azimuth angles.

21. The system of claim 13 wherein said analyzing module determines a maximal scanning range of said sensor.

22. The system of claim 13 wherein said graphic processing module enables simulating the position of said sensor within said precinct to generate a visibility map, said visibility map enabling the maximizing of a zone being in direct line-of-sight with said sensing element, within said region of interest.

23. The system of claim 13 wherein said graphic processing module indicates in said visibility map the zoom ranges of said sensor.

24. The system of claim 13 wherein said analyzing module determines a sequence of traversing said group of strips such that a scanning time of at least some of said region of interest is minimized.

25. The system of claim 16 wherein said analyzing module determines a sequence of traversing said group of strips, said sequence being determined by said module in a manner such that the angular difference between two strips is minimal compared to the angular difference between strips.

26. The system of claim 13, further comprising a workstation and a sensor wherein said scanning parameters are transmitted from said workstation to said sensor.

27. The system of claim 13, wherein said scanning parameters are updated substantially in real-time during the operation of said sensor.

28. The system of claim 13, wherein said region of interest is altered during the operation of the sensor.
